(19) United States
(12) Patent Application Publication
(10) Pub. No.: US 2011/0099471 A1
(43) Pub. Date: Apr. 28, 2011

(54) PRODUCT PREVIEW IN A PRODUCT SELECTION AND MANAGEMENT WORKFLOW

(76) Inventors: Phil Manijak, Corvallis, OR (US); Russell Mull, Corvallis, OR (US); Marc Frederick Ayotte, Corvallis, OR (US); Michael R. Wilson, Corvallis, OR (US); Pieter van Zee, Corvallis, OR (US)

(21) Appl. No.: 12/607,821

(22) Filed: Oct. 28, 2009

(51) Int. Cl. G06F 17/00

(52) U.S. Cl. 715/274; 358/1.18

(57) ABSTRACT

A product preview method for a plurality of selected products populated with a selected plurality of digital images includes causing a display of an image selection control. A digital image is identified that corresponds to a user's manipulation of the image selection control. A display is caused of a preview group containing a plurality of preview images for only those of the plurality of products selected to be populated with the identified digital image.

### BACKGROUND

Consumers order single and multi-image products via kiosks and web services. Single image products include image prints of various sizes. Multi-image products include collage posters, photo books, and the like. Embodiments discussed below allow a user to select and manage multiple single and multi-image products within a single workflow. The user can select the same digital image to populate multiple products. For example, a user may select utilize a digital image to produce single image prints of various sizes. The user may also select that same digital image in a collage poser, a photo book, and a calendar. With the new ability to select and manage multiple products in a single workflow, a problem arises in how to provide the user with an organized preview of the various products.

### DRAWINGS

FIGS. 1 and 2 depict exemplary environments in which embodiments may be implemented.

FIGS. 3-12 depict exemplary screen views of a user interface according to embodiments.

FIG. 13 depicts an exemplary product preview system according to an embodiment.

FIGS. 14-16 are block diagrams of environments in which the system of FIG. 13 may be implemented.

FIGS. 17 and 18 are flow diagrams depicting steps take to implement various embodiments.

### DETAILED DESCRIPTION

Various embodiments described below operate to provide a common workflow for selecting and editing single and multi image products. Within that workflow, the user is able to preview selected products. In particular, the user is presented, for each selected digital image, with a preview group displaying only those products for which that digital image was selected. The user can then step through the selected digital images one-by-one to preview the products selected for a given digital image.

The following description is broken into sections. The first, labeled “Environment,” describes exemplary environments in which embodiments may be implemented. The second section, labeled “Workflow,” describes a series of exemplary screen views depicting a common workflow for selecting, editing, and previewing single and multi-image products. The third section, labeled as “Components”, describes physical and logical components of various embodiments. The last section, labeled “Operation,” describes steps taken to implement various embodiments.

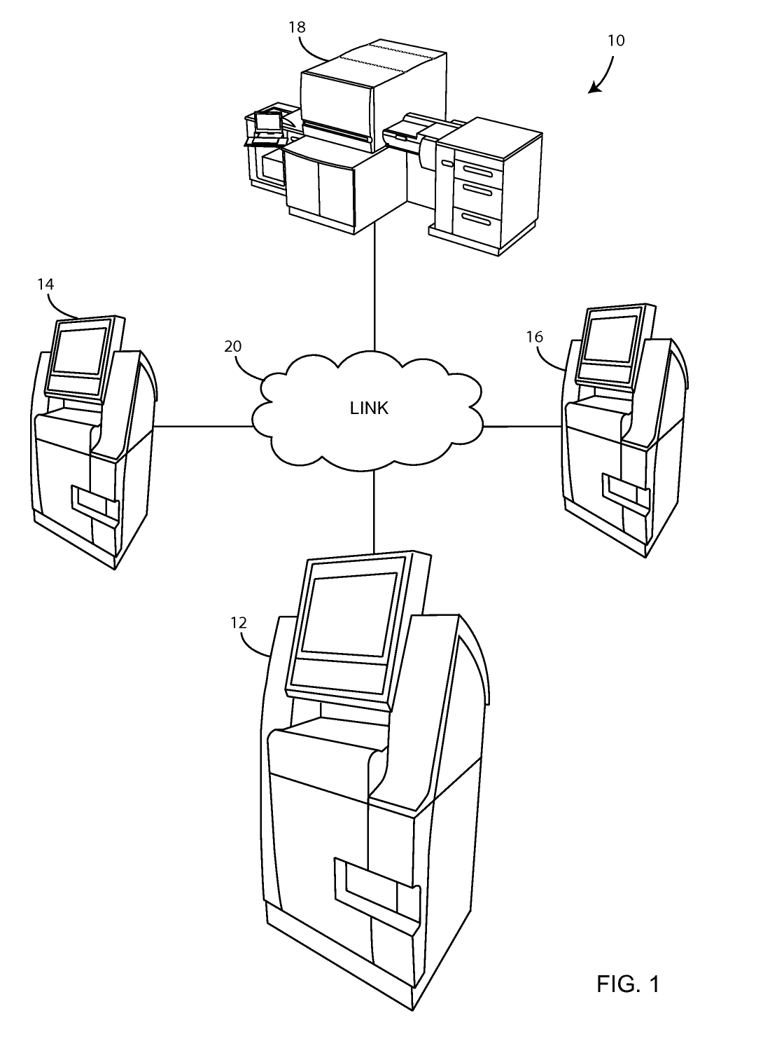

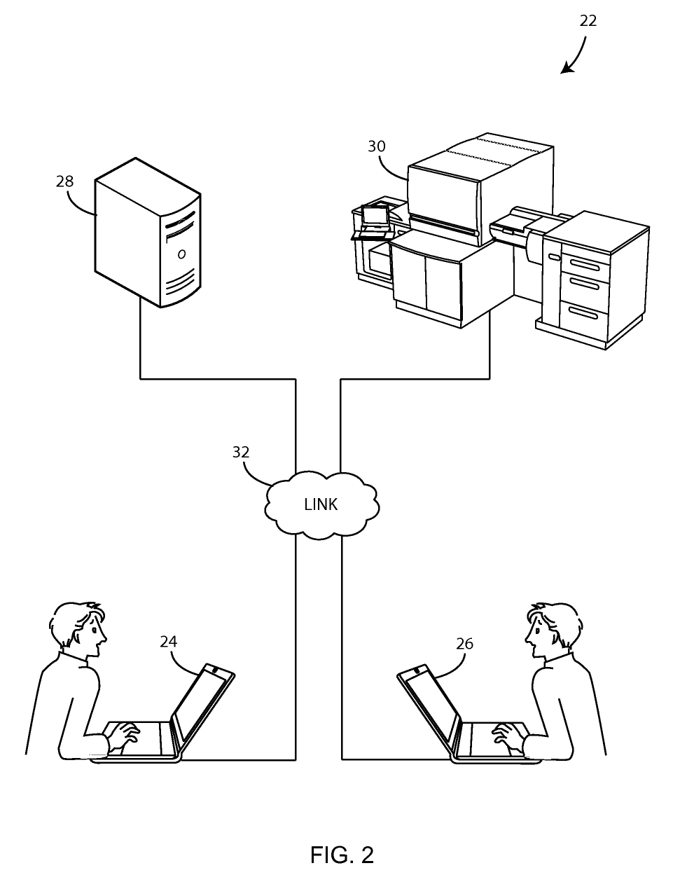

ENVIRONMENT: FIGS. 1-2 depict exemplary environments in which embodiments may be implemented. Starting with FIG. 1, environment 10 includes kiosks 12, 14, and 16 and production service 18 interconnected via link 20. Kiosks 12-16 each represent a computing device through which a user can select, edit, and order single and multi-image products. Each kiosk 12-16 presents a user interface via a display device. Often this display device incorporates a touch screen allowing the user to manipulate various controls with the touch or slide of a finger. Accessing digital images via a memory card or the internet, programming on each kiosk 12-16 allows a user to select from among the digital images, edit selected digital images, and order single and multi-image products populated with selected digital images.

Production service 18 represents generally any device or collection of devices capable of producing single and multi-image products ordered via kiosks 12-16. Link 20 represents generally one or more of a cable, wireless, fiber optic, or remote connection via a telecommunication link, an infrared link, a radio frequency link, or any other connector or system that provides electronic communication. Link 20 may represent an intranet, the Internet, or a combination of both. The paths followed by link 20 between kiosks 12-16 and production service 18 as depicted in FIG. 1 represent the logical communication paths between these devices, not necessarily the physical paths between the devices.

FIG. 2 depicts another environment 22 in which embodiments may be implemented. Environment 22 is shown to include client devices 24 and 26, server device 28, and production service 30 interconnected via link 32. Client devices 24 and 26 represent generally any computing devices capable of visually presenting a graphical user interface to a user and receiving user input via a touch screen, mouse, and/or a keyboard. Server device 28 represents generally any computing device capable of serving content to client devices 24, 26 that enable users to order single and multi-image products. Accessing digital images from client devices 24 or 26 or stored locally, server device 28 serves web pages or other content enabling users to select from among the digital images, edit selected digital images, and order single and multi-image products populated with selected digital images.

Production service 30 represents generally any device or collection of devices capable of producing single and multi-image products ordered via client devices 24, 26 and server device 28. Link 32 represents generally one or more of a cable, wireless, fiber optic, or remote connection via a telecommunication link, an infrared link, a radio frequency link, or any other connector or system that provides electronic communication. Link 32 may represent an intranet, the Internet, or a combination of both. The paths followed by link 32 between devices 24-30 as depicted in FIG. 2 represent the logical communication paths between these devices, not necessarily the physical paths between the devices.

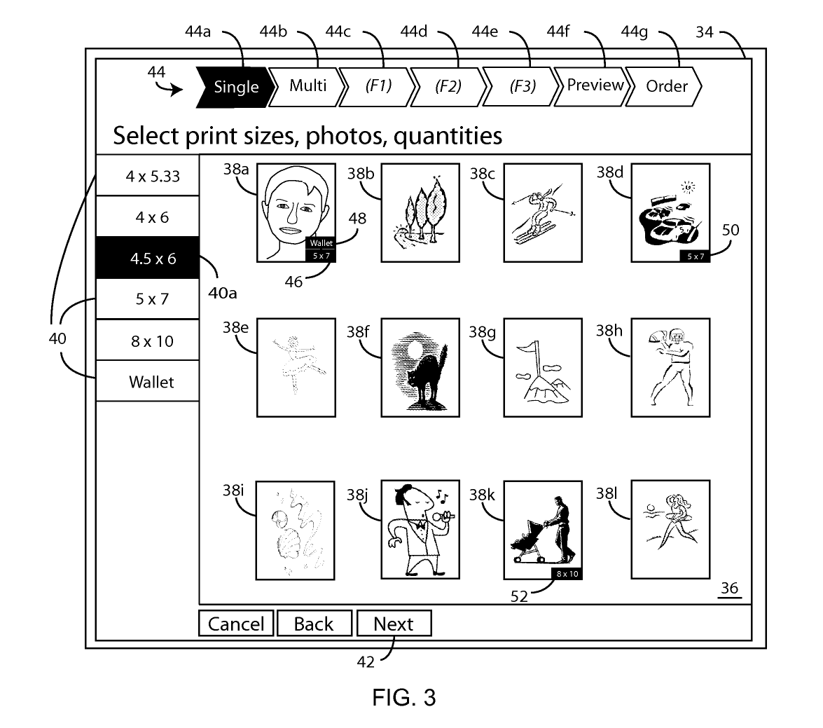

WORKFLOW: FIGS. 3-13 depict exemplary screen views of a user interface 34 through which a user can preview single and multi-image products selected via a common workflow. The term workflow as used herein refers to a defined series of tasks for producing a final outcome. From a user's perspective, initial tasks involve a user's selection from among various single and multi-image products as well as the user's selection of digital images for populating those products. A subsequent task can include editing each instance of a selected digital image used to populate a given product. Various selected products populated with selected and edited digital images can then be previewed and ultimately ordered. Ordering, for example, can include sending a job or jobs to a production service requesting the production of one or more user selected, populated, and edited products.

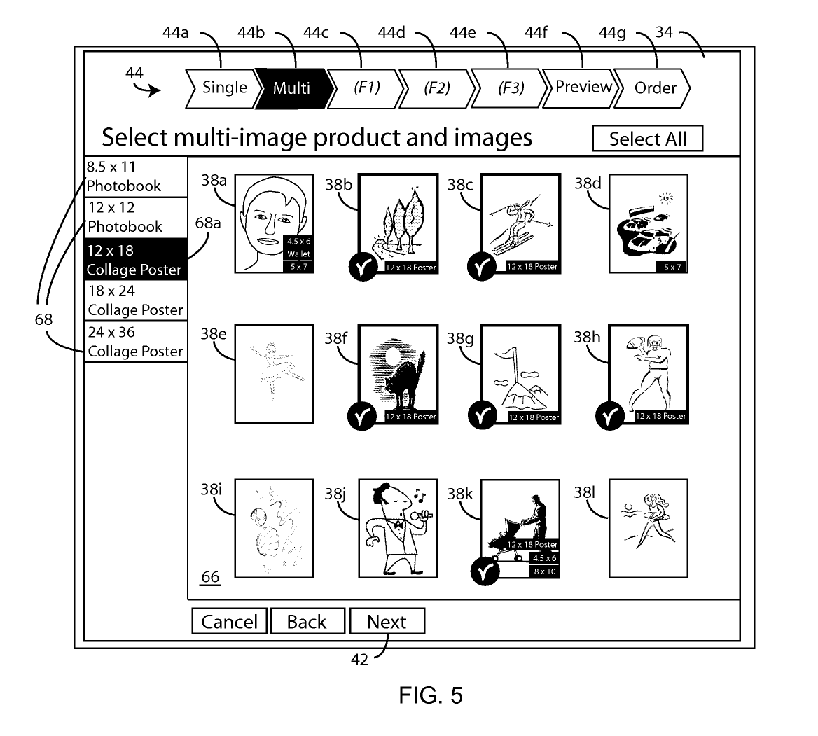

Starting with FIG. 3, user interface 34 is shown to include frame 36. The term frame as used refers to a defined area within user interface 34 for displaying text and graphics. As will be seen with respect to FIGS. 5-13, user interface 34 includes multiple frames. Some are displayed together at the same time while others are displayed sequentially as a user proceeds through the workflow. Displayed within frame 36 are thumbnails 38a-38l, referred to collectively as thumbnails 38. Each thumbnail 38 is a user selectable control providing a visual representation of a given digital image. In other words, a user selects a given digital image by selecting a corresponding thumbnail 38. Frame 36 is also shown to include product controls 40 for selecting from among a number of single image products.

User interface 34 includes workflow control 42 and workflow indicator 44. Workflow control 42 represents generally a user selectable control or controls enabling a user to sequence through various tasks of the workflow. Workflow indicator 44 represents a graphic or textual indication of an active task within the workflow. In the example of FIG. 3, task 44a is highlighted within task indicator 44. Task 44a involves the selection of print sizes, digital images, and quantities for single image products identified by product controls 40. Here a user has selected product control 40a corresponding to 4.5×6 prints. While no thumbnails 38 have been selected for 4.5×6 single image prints, thumbnail 38a has been modified with marking 46 and 48 to indicate that the user has previously selected the corresponding digital image to be used in producing a 5×7 single image print and wallet sized prints. Thumbnail 38d has been modified with marking 50 to indicate that the user has previously selected the corresponding digital image to be used in producing a 5×7 single image print. Finally, thumbnail 38k has been modified with marking 52 to indicate that the user has previously selected the corresponding digital image to be used in producing an 8×10 single image print.

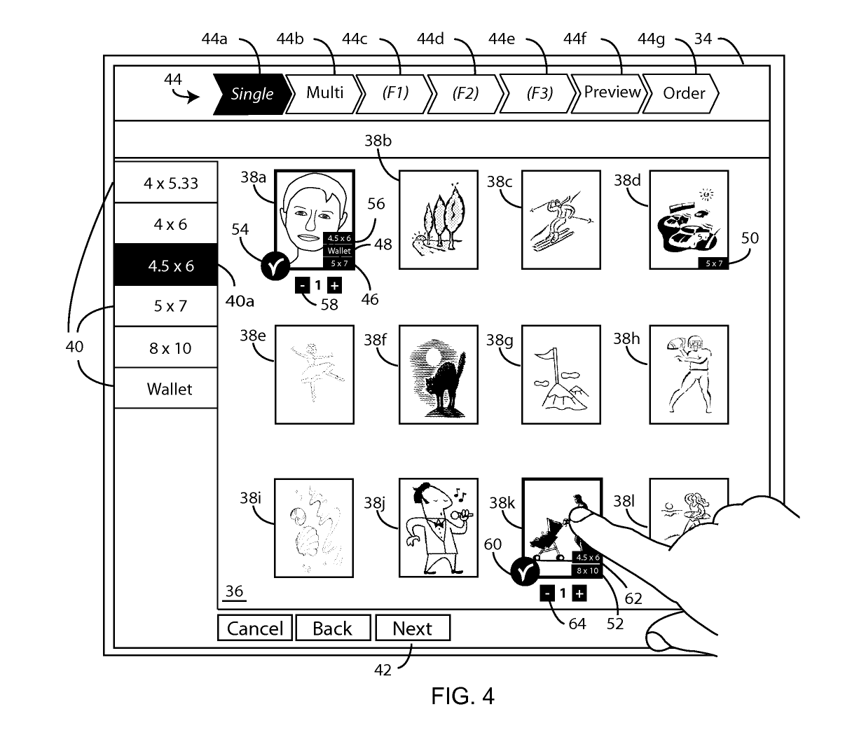

Moving to FIG. 4, the user has selected thumbnails 38a and 38k. As a result, thumbnail 38a has been modified with markings 54-58, and thumbnail 38d has been modified with markings 60-64. Markings 54 and 60 each provide an indication that a given thumbnail 38a and 38k has been selected with respect to currently selected product control 40a. Markings 56 and 62 indicate that the user has selected the corresponding digital images to be used in producing a 4.5×6 single image print. Markings 58 and 64 represent user selectable controls for selecting a number of 4.5×6 single image prints for each corresponding digital image. Here the user has indicated a desire for one 4.5×6 single image print for the digital images represented by thumbnails 38a and 38k.

With respect to FIGS. 3 and 4, the user's selection of the Wallet product control 40 followed by a selection of thumbnail 38a updated a list, often referred to as an electronic shopping cart, to include an order for a wallet print of the digital image represented by thumbnail 38a. The user's selection of the 8×10 product control 40 followed by a selection of thumbnail 38k updated the list to include an order for an 8×10 single image print of the digital image represented by thumbnail 38k. The user's selection of the 5×7 product control 40 followed by the selection of thumbnails 38a and 38d updated the list to include an order for a 5×7 single image print of the digital image represented by thumbnails 38a and 38d. The user's selection of the 4.5×6 product control 40a followed by the selection of thumbnails 38a and 38k updated the list to include an order for a one 4.5×6 single image print for each of the digital images represented by thumbnails 38a and 38k.

Assuming the user has finished selecting single image products, the user selects workflow control 42 stepping ahead to the next task in the workflow. Referring to FIG. 5, that next task is the selection of multi-image products and corresponding digital images for populating those products. The selection of workflow control 42 in FIG. 3 caused an update of workflow indicator 44 to indicate the current task 44b of selecting a multi-image product and digital images for populating the selected product. Replacing frame 36, user interface 34 now includes frame 66. Frame 66 includes thumbnails 38a-38l and product controls 68.

Product controls 68 allow a user to select from among a number of multi-image products. Here control 68a has been selected for a 12×18 collage poster. With control 68a selected, the user selects from among thumbnails 38a-38l to populate product a multi-image product. Here the user has selected thumbnails 38b, 38c, 38f, 38g, 38h, and 38k. The selection of product control 68a followed by the selection of thumbnails 38b, 38c, 38f, 38g, 38h, and 38k updated the list, discussed above, to include an order for a 12×18 collage poster populated with digital images corresponding to the selected thumbnails.

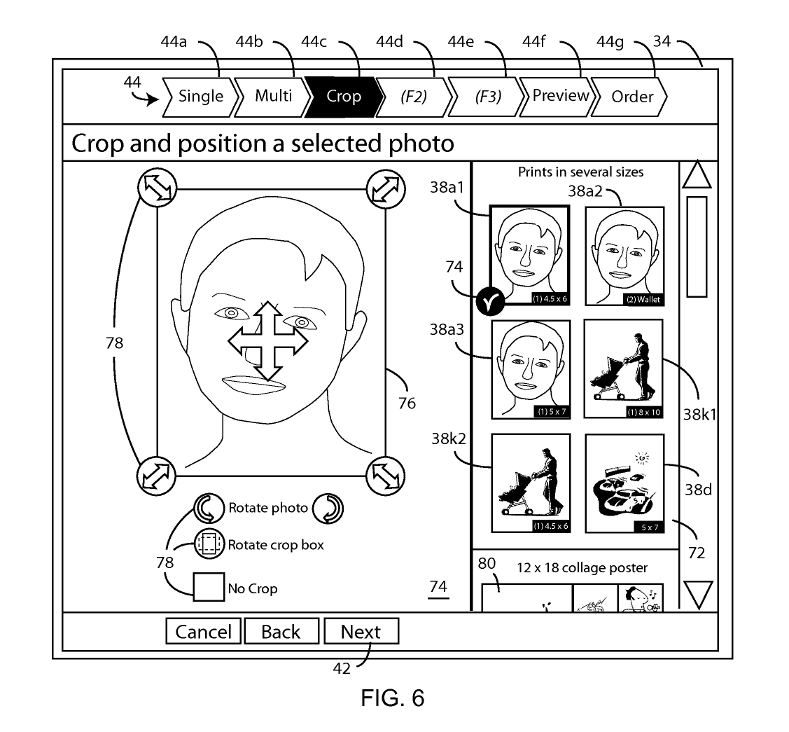

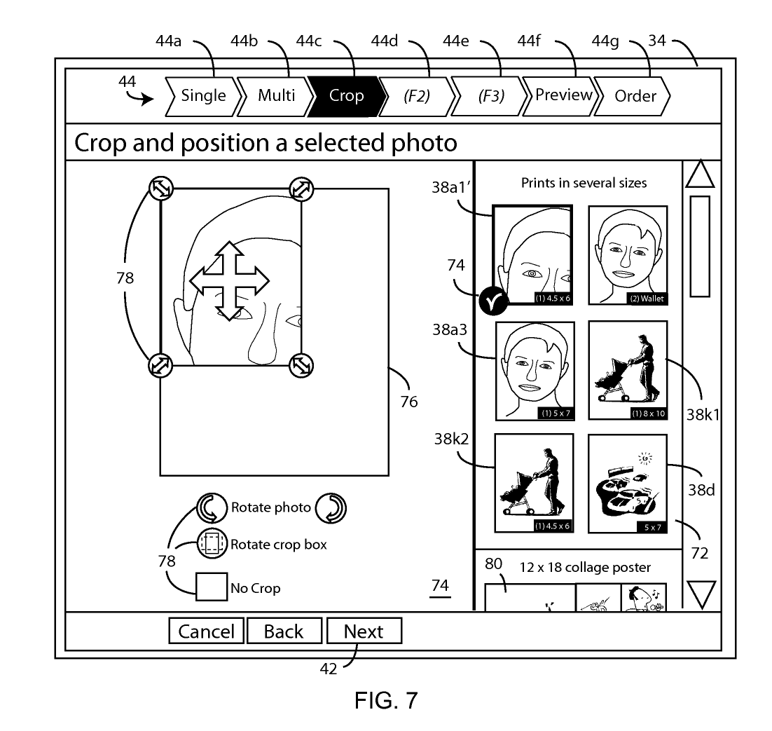

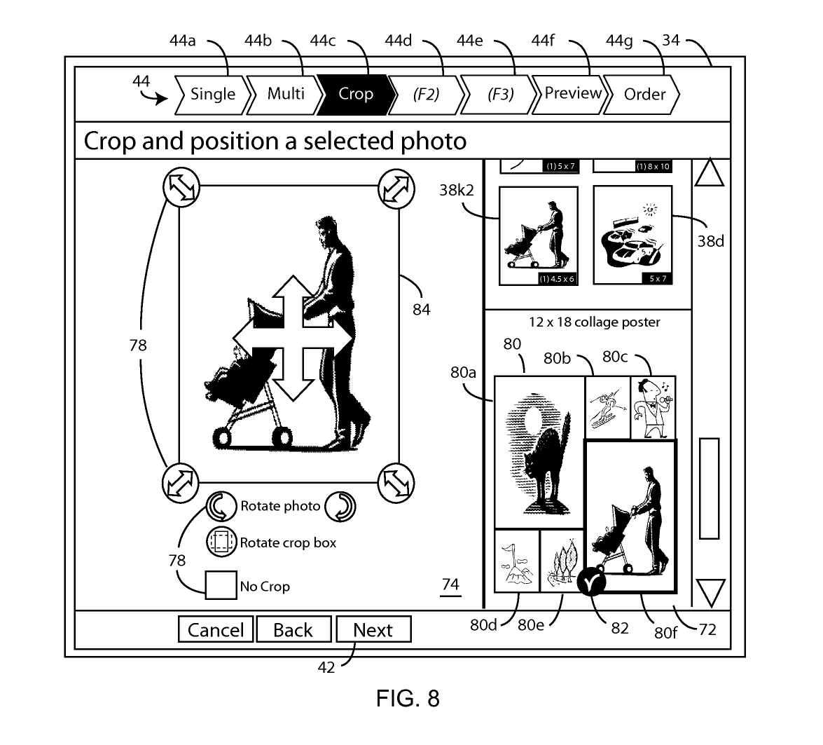

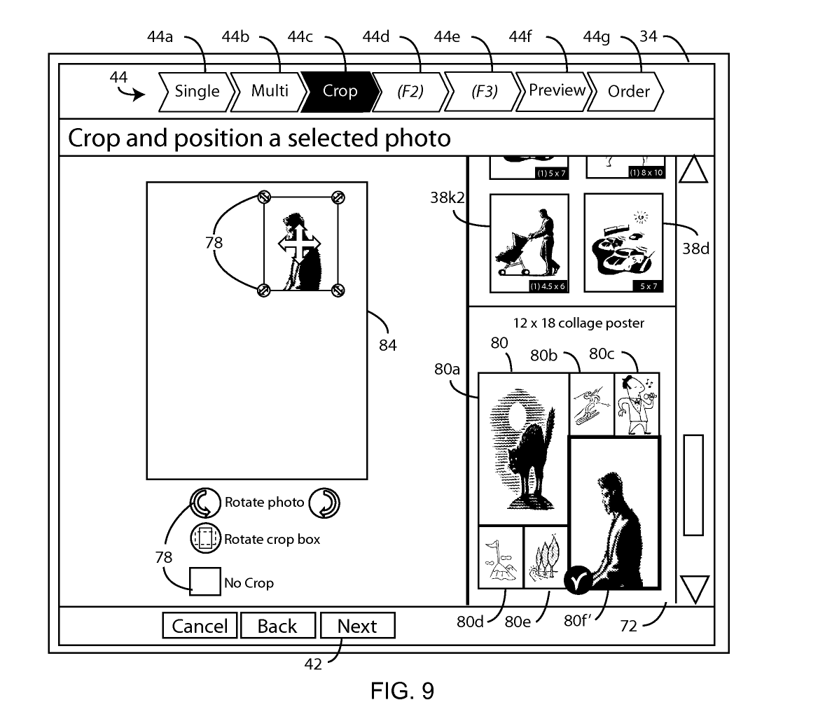

Assuming the user has finished selecting multi-image products, the user selects workflow control 42 stepping ahead to the next task 44c in the workflow. Referring to FIGS. 6-9, that next task involves providing an opportunity to edit each instance of a selected digital image used to populate a given product on the list. In the example of FIG. 6, editing includes cropping and positioning. Replacing frame 66, user interface 34 now includes frames 72 and 74. Frame 72 includes an individual thumbnail for each single image product included in the list (seen best in FIGS. 6 and 7) and a grouping of thumbnails for each multi-image product on the list (seen best in FIGS. 8 and 9). Frame 74 includes a product preview image corresponding to a thumbnail selected in frame 70. Referring to FIGS. 6 and 7, within frame 70, each individual thumbnail for a single-image product includes a representation of the digital image being used to populate that given single-image product. Referring to FIGS. 8 and 9, each grouping of thumbnails for a multi-image product includes individual thumbnails for each digital image used to populate that multi-image product.

In the example of FIG. 6, frame 72 includes thumbnails 38a, 38d1, 38d2, 38h, and 38k each corresponding to a single image product on the list as selected by the user in the previous workflow task 44a. While not completely visible, frame 70 also includes a grouping 80 of thumbnails corresponding to the multi-image product selected by the user in the previous workflow task 44b. Here, the user has selected thumbnail 38a as indicated by marking 74. As a result an editable product preview image 76 is displayed in frame 74.

Displayed with editable preview image 76 are controls 78 allowing the user to crop and position the digital image for a given single image product corresponding to the thumbnail 38a selected in frame 72. Referring to FIG. 7, once the user has cropped and positioned the digital image via the editable preview image 76, the single image product is modified accordingly. The corresponding thumbnail 38a′ in frame 72 is modified to provide an accurate preview of the modified single image product.

Moving to FIG. 8, the user has scrolled frame 72 to reveal grouping 80 of thumbnails corresponding to the multi-image product selected in workflow task 44b. Grouping 80 includes individually selectable thumbnails 80a-80f each corresponding to digital image selected by the user to populate the multi-image product. In the example of FIG. 8, the user has selected thumbnail 80a from grouping 80 as indicated by marking 82. As a result, editable preview image 84 is displayed in frame 74. Referring to FIG. 9, once the user has cropped and positioned the digital image via the editable preview image 84, the multi-image product is modified accordingly. The corresponding thumbnail 80a within grouping 80 in frame 70 is modified to provide an accurate preview of the modified multi-image product.

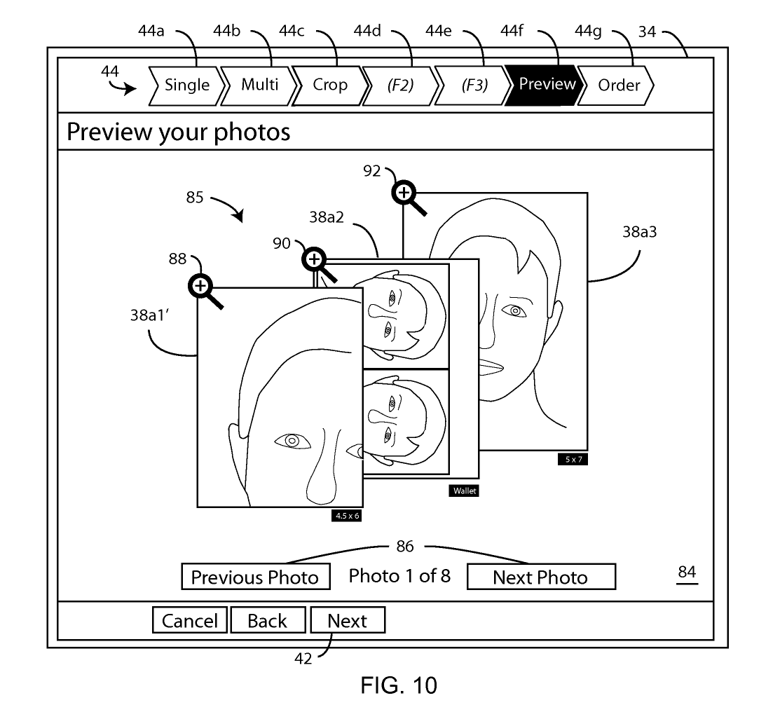

Via the workflow discussed with respect to FIGS. 3-9, a user has selected eight images represented by thumbnails 38a, 38, b, 38c, 38d, 38f, 38g, 38h, and 38k to populate seven different products. Referring to FIGS. 10-13, the user selects workflow control 42 skipping ahead to preview task 44f in the workflow. The preview task allows the user to preview, for each digital image, the products selected to be populated with that digital image.

Starting with FIG. 10, user interface 34 now includes frame 84, replacing frames 72 and 74. Frame 84 is shown to include preview group 85 and image selection control 86. Image selection control 86 represents generally any user interface control or controls that allow a user to select from among digital images previously selected to populate various products. Product preview group 85 represents generally a collection of preview digital images for only those products selected to be populated with a given digital image selected via image control 86. A preview image is an image of a selected product populated with the digital image selected via image control 86. In the example of FIG. 10, image selection control 86 has been manipulated to identify the digital image represented by thumbnail 38a of FIG. 3. As a result, product preview group includes preview images 38a1′, 38a2, and 38a3 corresponding to the three products selected to be populated with that digital image.

It is noted that each preview image includes a representation of the selected digital image as edited. In the Example of FIG. 10, preview image 38a1′ for the 4.5×6 single image print includes a cropped representation of the digital image while preview images 38a2 and 38a3 includes unedited versions. Further, preview images 38a1′, 38a2, and 38a3 are proportional in size to the products they represent. Here, preview images 38a1′ and 38a2 corresponds prints formed on 4.5×6 photo paper and thus appear equal in size. Preview image 38a3 corresponds to a 5×7 single image print and appears larger.

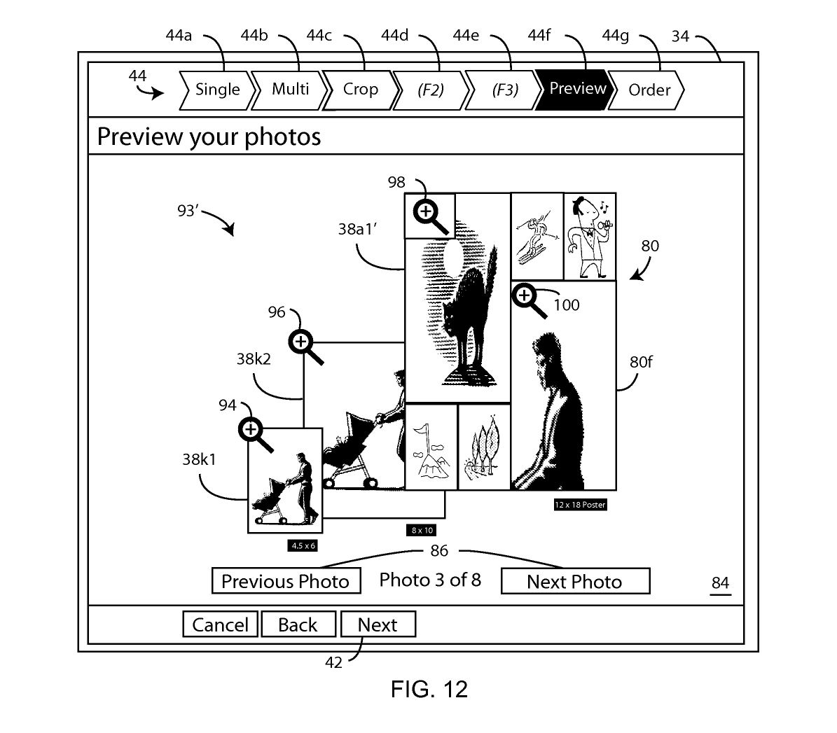

In the example of FIG. 10, each of preview images 38a1′, 38a2, and 38a3 may be user selectable via a touch screen, mouse, or other input device. The selection of a given preview image highlights that preview image within product preview group 85. In the examples of FIG. 10, preview image 38a1′ partially obscures preview image 38a2 which partially obscures preview image 38a3. Upon selection of preview image 38a3, product preview group 85 can be updated so that preview image 38a3 partially obscures one or both of preview images 38a2 and 38a1′. An example is discussed below with respect to FIG. 12.

Preview images 38a1′, 38a2, and 38a3 are each shown to include a user selectable preview control (controls 88-92, respectively) each depicted, in this example, as a magnifying glass. Selection of a given preview control 88-92 causes an enlarged preview image of the corresponding product as populated with the digital image identified using image selection control 86. The enlargement may, for example, be a full-screen preview.

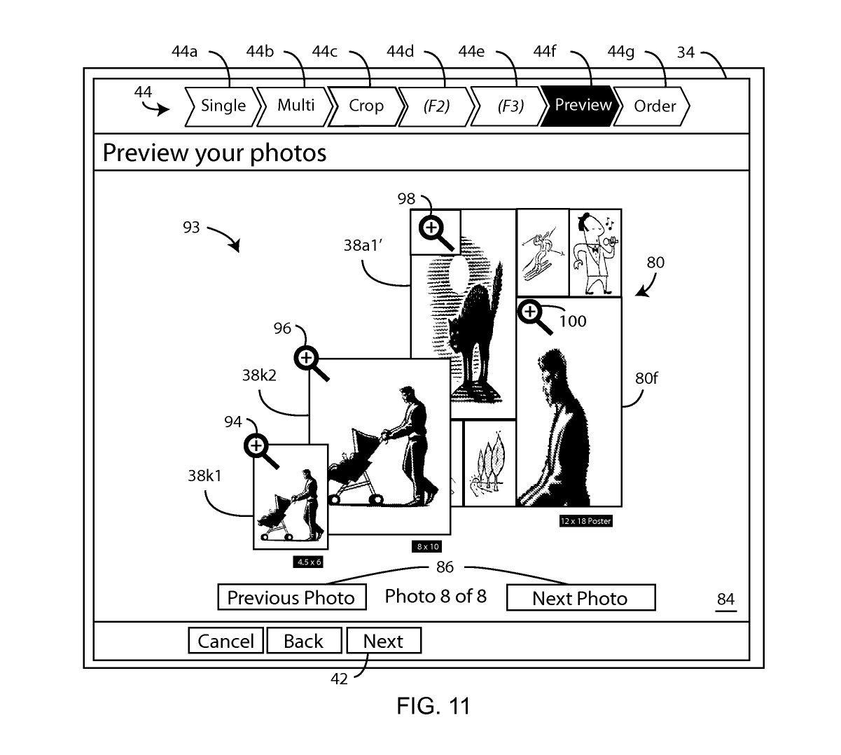

Moving to FIG. 11, the user has manipulated image selection control 86 to identify the digital image represented by thumbnail 38k in FIG. 3. The manipulation causes the display of product preview group 93 replacing product preview group 85 in frame 84. Product preview group 93 includes product preview images 38k1, 38k2, and 80 corresponding to the three products selected above to be populated with the digital image represented by thumbnail 38k. As above with respect product preview group 85, each preview image in product preview group 93 may be user selectable. Looking at FIG. 12, a user has selected and caused preview image 80 to be highlighted. In this example, preview image 80 has been highlighted by bringing it to the front of product preview group 93 so that it partially obscures preview image 38k2. Such is only an example; preview mage 80 could be highlighted in any fashion that provides a visual indication that it has been selected.

Referring back to FIG. 11, each preview image 38k1, 38k2, and 80 includes a preview control (controls 94-98, respectively) each depicted, in this example, as a magnifying glass. Selection of a given preview control 94-98 causes an enlarged preview image of the corresponding product as populated with the digital image identified using image selection control 86. The enlargement may, for example, be a full-screen preview. In the example of FIG. 11, product preview group 93 includes preview image 80 for a multi-image product selected to be populated with the digital image represented by thumbnail 38k in FIG. 3 as represented by cell 80f. Cell 80f is shown to include preview control 100, the selection of which cases the display of an enlarged editable preview of the multi-image product.

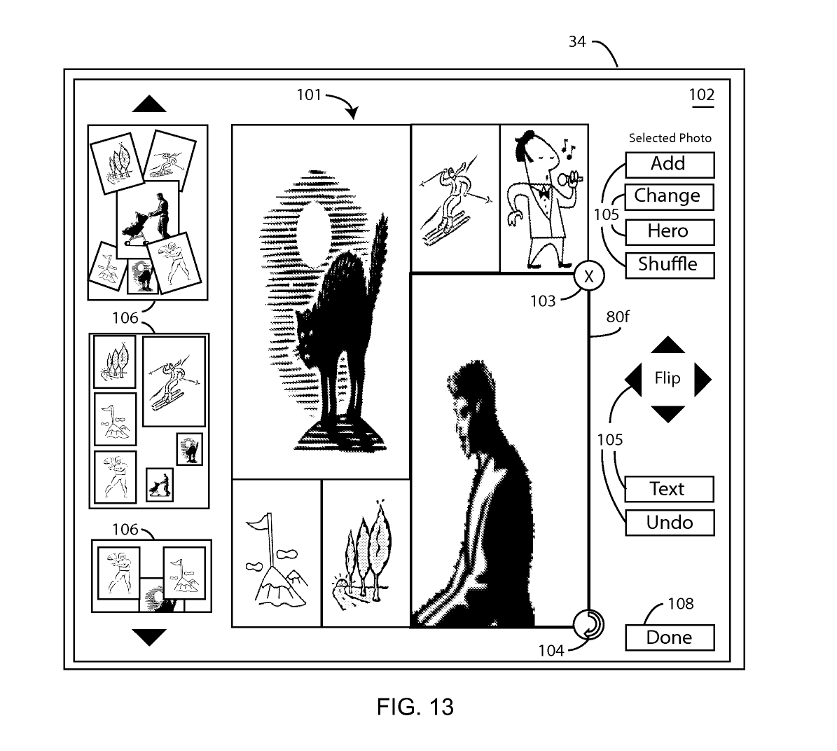

FIG. 13 depicts an example of an enlarged editable preview 101 of a multi image product within frame 102 of user interface 34. Preview 101 includes controls 103-105 for manipulating cell 80f. Also included is control 106 for selecting different layouts for the multi-image product. Control 108 allows the user to return to the previous frame within user interface 34.

Via the exemplary user interface 34 of FIGS. 3-13 a user is able to manage and order single and multi image products in a single workflow. Within that workflow, the user can select a desired digital image or images for populating each product being ordered. The user can also edit each instance of a digital image selected to populate a given product. Finally, the user is able to preview, for each selected digital image, those products selected to be populated with that digital image.

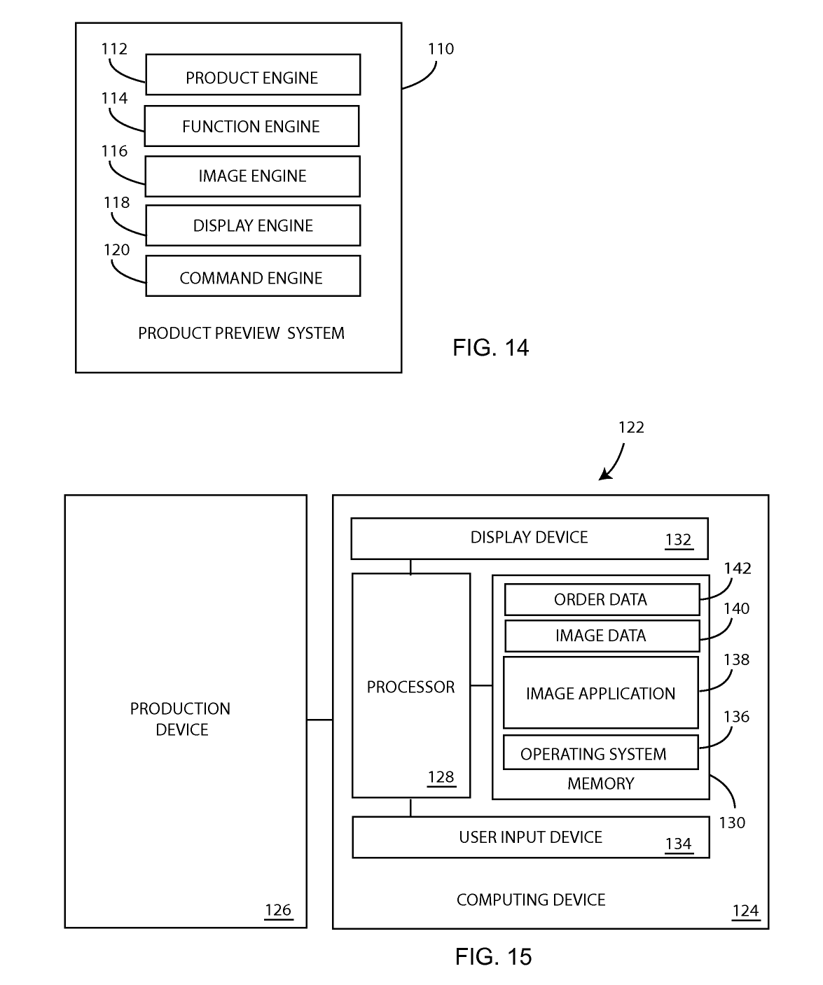

COMPONENTS: FIG. 14 depicts various physical and logical components that function as product preview system 110. System 110 is shown to include product engine 112, function engine 114, image engine 116, display engine 118, and command engine 120. Product engine 112 represents generally any combination of hardware and programming for defining the single and multi-image products available for ordering. Definitions for the single image products can define print sizes and the available media on which the digital images can be formed. Such media can include photo paper, coffee mugs, clothing, and the like. Thus, one single image product may include an eight by ten image formed on photo paper. Another single image product may be defined as four by four image formed on a mouse pad.

Function engine 114 represents generally any combination of hardware and programming configured to define one or more functions for editing digital images selected to populate a product or products. Such functions can include cropping, positioning, color management, red-eye removal, adding borders, and the like.

Image engine 116 represents generally any combination of hardware and programming configured to generate and modify objects to be displayed as part of a user interface. In particular, image engine 116 is responsible for generating thumbnails from a set of digital images. Image engine 116 is also responsible for generating and modifying thumbnails to be displayed in various frames of a user interface. Initially, image engine 116 is responsible for generating a first set of thumbnails for each of a set of digital images available to a user. Upon selection of a thumbnail from the first set, image engine 116 is responsible for modifying that thumbnail to indicate its selection for populating a give product with a corresponding digital image. FIGS. 3-5, discussed above, provide examples.

Image engine 116 is responsible for generating a second set of thumbnails. The second set includes a thumbnail for each instance of a digital image selected to populate a single image product and groupings of thumbnails for digital images selected to populate one or more multi-image products. Upon selection of a thumbnail from the second set, image engine 116 is responsible generating a corresponding editable preview image. Image engine 116 modifies a thumbnail selected from the second set to reflect the manner in which the editable preview image has been manipulated by a user. FIGS. 6-9, discussed above, provide examples.

Image engine 116 is responsible for generating preview groups for each digital image selected to populate one or more products. A preview group is a collection of preview images for products populated with the same digital image. Each preview image in a product preview group, when displayed, provides a visual representation of a different product populated with the same digital image. FIGS. 10-12 provide examples. When proceeding through a workflow, a user selects from among a group of digital images for use in populating various single and multi image products. Each digital image may be used to populate multiple products. Thus, each product preview group generated by image engine 116 corresponds to a given digital image and includes preview images for only those products selected to be populated with that digital image.

As noted, each preview image in a product preview group corresponds to one of a number of possible products of various sizes. Image engine 116 generates each product preview group such that, when displayed, the preview images are sized in proportion to the products they represent. When proceeding through a workflow to populate a product with a given digital image, the user may edit that digital image as it is to appear in that product. Such edits can include cropping, positioning, red eye removal, and the like. Thus, when generating each product preview group, image engine 116 generated each preview image to include a representation of the digital image as edited for use in the corresponding product. Thus, a first preview image can include one representation of a digital image edited in one manner while a second preview image includes a representation edited in a different manner. FIGS. 10-12 provide examples.

Upon detection of a users selection of a given preview image, image engine 116 modifies the preview group to emphasize that preview image over the other preview images in the group. Emphasizing can involve modifying the product preview group such that the selected preview image, when displayed, is fully visible and partially obscures one or more of the other preview images. FIG. 12 provides an example.

Image engine 116 adds a preview control to each preview image. FIGS. 10-12 provide examples. Upon a user's selection of a preview control, image engine 116 generates an enlarged preview image for the product represented by that preview image containing the selected preview control. For multi-image products, the enlarged preview image may be editable. FIG. 13 provides an example.

Display engine 118 represents generally any combination of hardware and programming configured to cause, in accordance with a current workflow task, the display of objects generated and modified by image engine 116. Such objects include thumbnails, preview groups, and enlarged preview images. Display engine 118 is also responsible for causing the display of various controls including product selection controls, workflow controls, image selection controls, and editable product preview images as indicated by the current workflow task. FIGS. 3-12, discussed above, provide examples.

Command engine 120 represents generally any combination of hardware and programming configured to detect a user's selections from among the objects caused to be displayed by display engine 118. In a given example, command engine 120 identifies an initial digital image corresponding to a user's manipulation of an image selection control allowing display engine 118 to cause a display of an initial product preview group for that identified digital image. As discussed, the product preview group is generated by image engine 116 and includes preview images for only those precuts selected to be populated with the identified digital image. Command engine 120 can identify a subsequent digital image corresponding to a user's subsequent manipulation of the image selection control allowing display engine 118 to cause a display of subsequent product preview group corresponding to that subsequent digital image. The subsequent product preview group replaces the initial product preview group within a user interface.

System 110 of FIG. 10 may be implemented in a number of environments such as environment 122 of FIG. 15. Environment 122 includes computing device 124 and production device 126. Computing device 124 may be a general purpose computer, a specialized kiosk, or an integrated sub-system of production device 126. Production device 126 represents generally any device or collection of devices capable of producing single and multi-image products ordered via computing device 124.

Computing device 124 is shown to include processor 128, memory 130, display device 132, and user input device 134. Processor 128 represents generally any device capable of executing program instructions stored in memory 130. Memory 130 represents generally any memory configured to store program instructions and other data. Display device 132 represents generally any display device capable of displaying a graphical user interface at the direction of processor 128. User input device 134 represents generally any device such as a mouse, keyboard, or a touch screen through which a user can interact with a user interface presented via display device 132.

Memory 130 is shown to include operating system 136, image application 138, image data 140, and order data 142. Operating system 136 represents generally any software platform on top of which other programs or applications such as image application 138 run. Examples include Linux® and Microsoft Windows®. In this example, operating system 136 includes drivers for controlling the operation of components 132 and 134. In particular, these drivers translate generic commands into device specific commands capable of being utilized by components 132 and 134.

Image application 138 represents generally any programming that, when executed, implements the functionality of engines 112-120 of FIG. 14. Image data 140 represents the digital images image application 146 acts upon. Order data 142 represents data identifying single and multi image products ordered by a user. As noted above, the various components of system 110 of FIG. 14 include combinations of hardware and programming. With respect to FIG. 15, the hardware components may be implemented though processor 128. The programming elements may be implemented via image application 138. In particular, the workflow for selecting, editing, and previewing single and multi-image products may be presented via a user interface generated and managed by image application 138.

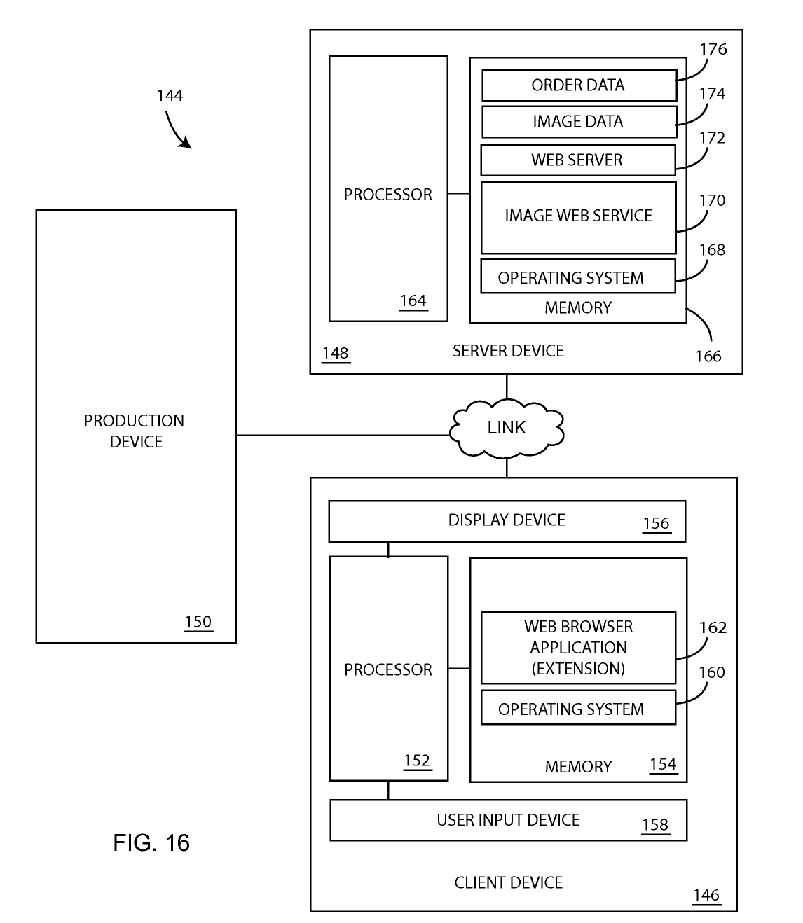

System 110 of FIG. 14 may be implemented in environment 144 of FIG. 16. Environment 144 includes client device 146, server device 148, and production device 150. Client device 146 may be a general purpose computer, a specialized kiosk, or an integrated sub-system of production device 150. Server device 148 represents any computing device capable of serving content. Production device 150 represents generally any device or collection of devices capable of producing single and multi-image products ordered via client device 146 and server device 148.

Client device 146 is shown to include processor 152, memory 154, display device 156, and user input device 158. Processor 152 represents generally any device capable of executing program instructions stored in memory 154. Memory 154 represents generally any memory configured to store program instructions and other data. Display device 156 represents generally any display device capable of displaying a graphical user interface at the direction of processor 152. User input device 158 represents generally any device such as a mouse, keyboard, or a touch screen through which a user can interact with a user interface presented via display device 132.

Memory 154 is shown to include operating system 160 and web browser application 162. Operating system 160 represents generally any software platform on top of which other programs or applications such as web browser application 162 run. Examples include Linux® and Microsoft Windows®. In this example, operating system 160 includes drivers for controlling the operation of components 156 and 158. In particular, these drivers translate generic commands into device specific commands capable of being utilized by components 156 and 158. Web browser application 162 represents generally any programming that, when executed by processor 152, requests and causes a display of content served by server device 148. Web browser application 138 is also responsible for communicating data indicative of user input back to server device 148.

Server device 148 is shown to include processor 164 and memory 166. Processor 164 represents generally any device capable of executing program instructions stored in memory 166. Memory 166 represents generally any memory configured to store program instructions and other data. Memory 166 is shown to include operating system 168, image web service 170, web server 172, image data 174, and order data 176. Operating system 168 represents generally any software platform on top of which other programs or applications such as service 170 and server 172 run. Examples include Linux® and Microsoft Windows®.

Image web service 170 in combination with web server 172 represents generally any programming that, when executed, implements the functionality of engines 112-120 of FIG. 14. Image data 174 represents the digital images image web service 170 acts upon. Order data 176 represents data identifying single and multi image products ordered by a user and indicated by communications received by web server 172 from client device 146.

As noted above, the various components of system 110 of FIG. 14 include combinations of hardware and programming. With respect to FIG. 16, the hardware components may be implemented though processor 164. The programming elements may be implemented via image web service 170 and web server 172. In particular the workflow for selecting and editing single and multi-image products may be presented and managed via content generated by image web service 170 and served by web server 172.

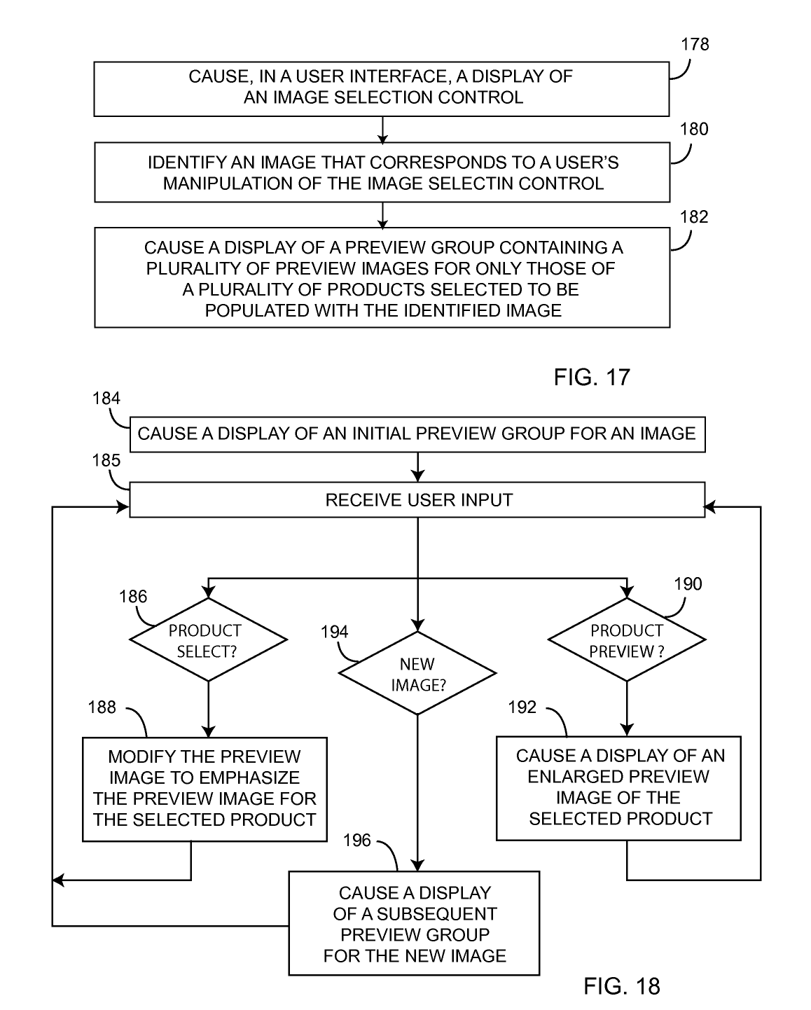

OPERATION: FIGS. 17-18 are exemplary flow diagrams of steps taken to implement various embodiments providing a common workflow for selecting and editing single and multi image products. In discussing FIGS. 17-18, reference may be made to the diagrams of FIGS. 1-16 to provide contextual examples. Implementation, however, is not limited to those examples.

Starting with FIG. 17, a method includes causing, in a user interface, a display of an image selection control (step 178). A digital image is identified that corresponds to a user's manipulation of the image selection control (step 180). Referring to FIG. 14, display engine 14 may be responsible for implementing step 178. FIGS. 10-12 depict an exemplary image selection control 86. Command engine 120 may be responsible for implementing step 180. In the examples of FIGS. 3-13, a user had selected eight different digital images to populate various products. Image selection control 86, in this example, allows a user to sequence through those eight digital images one at a time. Thus, a user's manipulation of image selection control corresponds to a selected of those digital images. Command engine 120 is responsible for detecting the manipulation an identifying the corresponding digital image.

A display is caused of a preview group (step 182). That product preview group contains a preview image for only those of a plurality of products selected to be populated with the digital image identified in step 180. Referring again to FIG. 14, image engine 116 and display engine 118 may be responsible for implementing step 182. Image engine 116 generates the product preview group for the digital image identified by command engine 120. Display engine 118 causes the product preview group to be displayed. FIGS. 10-12 depict exemplary displays of product preview groups 85 and 93.

It is noted that the various products represented by the product preview group may be of various different sizes. In generating the product preview group, image engine 116 may size each preview image in proportion to the dimensions of the product it represents. Thus, when displayed, preview images of the product preview group are relatively sized with respect to one another and the products they represent. It is also noted that the digital image selected to populate the various products of the product preview group may be edited differently for each product. Thus, one preview image may include one version of the digital image edited in one manner while a second preview image may contain another version of the digital image edited in a second manner. FIG. 10 depicts an example, preview image 38a1′ contains c cropped version of a selected digital image while preview group 38a3 contains a full version.

FIG. 18 expands on the method depicted in FIG. 17. Here, the product preview group of step 182 in FIG. 17 is an initial product preview group caused to be displayed in step 184. From here the process waits for user input (step 185). That user input may be detected as a user's selection of a particular product within the preview group (step 186). Each preview image in the product preview group caused to be displayed in step 184 may be user selectable. Thus, a product is selected by selecting its preview image within the displayed product preview group. Following detection of a particular product's selection in step 186, the currently displayed product preview group is modified to emphasize the preview image of the selected product (step 188). Referring to FIG. 14, command engine 120 may be responsible for detecting a user's selection of a given preview image. Upon the detection, Image engine 116 modifies the product preview group to emphasize that preview image. FIG. 12 provides an example in which preview image 80 has been emphasized such that it partially obscures preview image 38k2 within product preview group 93′.

The user input of step 185 may be detected as a user's selection of a preview control included on a particular preview image of the displayed product preview group (step 190). Following the detected selection of the preview control, an enlarged preview image is caused to be displayed (step 192). The enlarged preview image corresponds to the preview image containing the selected preview control. Referring to FIG. 14, command engine 120 may be responsible for detecting a user's selection of a preview control in step 190. FIGS. 10-12 depict preview images with exemplary preview controls 88-100. FIG. 13 depicts the exemplary display of an enlarged preview image 101 that is editable.

The user input of step 185 may be detected as a user's selection of a new digital image (step 194). A new digital image is selected by manipulating an image selection control displayed as part of the user interface. Upon such detection in step 194, a subsequent product preview group is caused to be displayed for the new digital image (step 196). That subsequent product preview group may replace the Initial product preview image within the user interface and include preview images for only those of a plurality of products selected to be populated with the new digital image. Referring again to FIG. 14, command engine 120 may be responsible for detecting a user's manipulation of the image selection control and a corresponding selection of the new digital image. Image engine 116 is responsible for generating the subsequent product preview group for that new digital image, while display engine 118 is responsible for causing the display of the subsequent product preview group.

### CONCLUSION

The diagrams of FIGS. 1-13 are used to depict exemplary environments, components, and user interface displays. Implementation, however, is not so limited. FIGS. 14-16 show the architecture, functionality, and operation of various embodiments. Various components illustrated in FIGS. 14-16 are defined at least in part as programs. Each such component, portion thereof, or various combinations thereof may represent in whole or in part a module, segment, or portion of code that comprises one or more executable instructions to implement any specified logical function(s). Each component or various combinations thereof may represent a circuit or a number of interconnected circuits to implement the specified logical function(s).

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIG. 17-18 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details and embodiments may be made without departing from the spirit and scope of the invention that is defined in the following claims.

What is claimed is:

1. A product preview method for a plurality of selected products populated with a selected plurality of digital images, the method comprising:
causing a display of an image selection control;
identifying a digital image that corresponds to a user's manipulation of the image selection control; and
causing a display of a preview group containing a plurality of preview images for only those of the plurality of products selected to be populated with the identified digital image.

2. The method of claim 1, wherein the plurality of product preview images are each user selectable, the method further comprising, upon detection of a users selection of one of the plurality of preview images, modifying the preview group to emphasize the selected preview image over another product preview image.

3. The method of claim 2, wherein, within the preview group, a first preview image is positioned to partially obscure a second preview image and wherein modifying the preview group comprises, upon detection of a user's selection of the second preview image, modifying the preview group such that the second preview image partially obscures the first preview image.

4. The method of claim 1, wherein causing a display comprises causing a display of a preview group containing:
a first preview image of a first selected product populated with a first representation of the identified digital image edited in a first manner, and
a second preview image of a second selected product populated with a second representation of the identified digital image edited in a second manner different than the first manner;
wherein the first preview image and the second preview image are relatively sized with respect to one another according to the relative sizes of the first and second selected products.

5. The method of claim 4, wherein the first preview image includes a first user selectable preview control and the second preview image includes a second user selectable preview control, the method further comprising:
upon user selection of the first preview control, causing a display of an enlarged preview image of the first selected product populated with the identified digital image edited in the first manner; and
upon user selection of the second preview control, causing a display of an enlarged preview image of the second selected product populated with the identified digital image edited in the second manner.

6. The method of claim 5, wherein the second selected product is a multi-image product and wherein preview image of the second selected product is an editable preview image of the multi-image product.

7. The method of claim 1, wherein the identified digital image is a first image, the user's manipulation of the image selection control is a first manipulation, the preview group is a first preview group, and the plurality of preview images is a first plurality of preview images, the method further comprising:
identifying a second digital image that corresponds to a user's second manipulation of the image selection control; and
causing a display of a second preview group containing a second plurality of preview images for only those of the plurality of products selected to be populated with the identified second digital image, the second preview group replacing the first preview group.

8. A computer readable medium storing computer executable instructions that when executed implement a product preview method for a plurality of selected products populated with a selected plurality of digital images, the method comprising:
causing a display of an image selection control;
identifying a digital image that corresponds to a user's manipulation of the image selection control; and
causing a display of a preview group containing a plurality of preview images for only those of the plurality of products selected to be populated with the identified digital image.

9. The medium of claim 8, wherein the plurality of product preview images are each user selectable, the method further comprising, upon detection of a user's selection of one of the plurality of preview images, modifying the preview group to emphasize the selected preview image over another product preview image.

10. The medium of claim 9, wherein, within the preview group, a first preview image is positioned to partially obscure a second preview image and wherein modifying the preview group comprises, upon detection of a user's selection of the second preview image, modifying the preview group such that the second preview image partially obscures the first preview image.

11. The medium of claim 8, wherein causing a display comprises causing a display of a preview group containing:
a first preview image of a first selected product populated with a first representation of the identified digital image edited in a first manner, and
a second preview image of a second selected product populated with a second representation of the identified digital image edited in a second manner different than the first manner;
wherein the first preview image and the second preview image are relatively sized with respect to one another according to the relative sizes of the first and second selected products.

12. The medium of claim 11, wherein the first preview image includes a first user selectable preview control and the second preview image includes a second user selectable preview control, the method further comprising:
upon user selection of the first preview control, causing a display of an enlarged preview image of the first selected product populated with the identified digital image edited in the first manner; and
upon user selection of the second preview control, causing a display of an enlarged preview image of the second selected product populated with the identified digital image edited in the second manner.

13. The medium of claim 12, wherein the second selected product is a multi-image product and wherein preview image of the second selected product is an editable preview image of the multi-image product.

14. The medium of claim 8, wherein the identified digital image is a first image, the user's manipulation of the image selection control is a first manipulation, the preview group is a first preview group, and the plurality of preview images is a first plurality of preview images, the method further comprising:
identifying a second digital image that corresponds to a user's second manipulation of the image selection control; and
causing a display of a second preview group containing a second plurality of preview images for only those of the plurality of products selected to be populated with the identified second digital image, the second preview group replacing the first preview group.

15. A system for previewing a plurality of selected products populated with a selected plurality of digital images, comprising an image engine, a display engine, and a command engine, wherein:
the command engine is operable to identify a digital image that corresponds to a user's manipulation of an image selection control; and
the image engine is operable to generate a preview group containing a plurality of preview images for only those of the plurality of products selected to be populated with the identified digital image; and
the display engine is operable to cause a display of the image selection control and the preview group.

16. The system of claim 15, wherein each of the plurality of product preview images is user selectable, and wherein:
the command engine is operable to detect a user's selection of one of the plurality of preview images; and
the image engine is operable to modify the preview group to emphasize the selected one of the plurality of preview images over another product preview image.

17. The system of claim 16, wherein, within the preview group, a first preview image is positioned to partially obscure a second preview image and wherein the image engine is operable to modify the preview group such that the second preview image partially obscures the first preview image upon the command engine detecting the user's selection of the second preview image.

18. The system of claim 15, wherein the image engine is operable to generate a preview group containing:
a first preview image of a first selected product populated with a first representation of the identified digital image edited in a first manner, and
a second preview image of a second selected product populated with a second representation of the identified digital image edited in a second manner different than the first manner;
wherein the first preview image and the second preview image are relatively sized with respect to one another according to the relative sizes of the first and second selected products.

19. The system of claim 18, wherein:
the first preview image includes a first user selectable preview control and the second preview image includes a second user selectable preview control;
the command engine is operable to detect a user's selection of the first and second preview controls;
the image engine is operable to generate a first enlarged preview image of the first selected product populated with the identified digital image edited in the first manner and an enlarged preview image of the second selected product populated with the identified digital image edited in the second manner; and
the display engine is operable to cause a display of the first enlarged preview image upon a detected selection of the first preview control and to cause a display of the second enlarged preview image upon a detected selection of the second preview control.

20. The system of claim 19, wherein the second selected product is a multi-image product and wherein the second enlarged preview image is an editable preview image of the multi-image product.
